(19) United States
(12) Patent Application Publication
(10) Pub. No.: US 2016/0063601 A1
(43) Pub. Date: Mar. 3, 2016

(54) INFORMATION PROCESSING DEVICE AND COMPUTER READABLE MEDIUM

(71) Applicant: CASIO COMPUTER CO., LTD., Tokyo (JP)

(72) Inventor: Masaharu MEKI, Tokyo (JP)

(73) Assignee: CASIO COMPUTER CO., LTD., Tokyo (JP)

(21) Appl. No.: 14/815,387

(22) Filed: Jul. 31, 2015

(30) Foreign Application Priority Data
Aug. 28, 2014 (JP) 2014-173412

(51) Int. Cl. G06Q 30/06

(52) U.S. Cl. CPC G06Q 30/0631

(57) ABSTRACT

An information processing device includes a first extracting unit and a creating unit. The first extracting unit compares a first list of a product or service created for a customer before purchase and a second list of a product or service purchased by the customer, and guesses and extracts a product or service which the customer has a potential desire to purchase. The creating unit creates a third list including the extracted product or service.

### BACKGROUND OF THE INVENTION

1. Field of the Invention

The present invention relates to an information processing device and a computer readable medium.

2. Background Art

A typical building company that builds or renovates a structure usually provides information for promoting purchase of new products to customers who are owners of houses and/or building equipment, such as kitchens, that have been built or installed by the building company. Recommendation on product purchase has been performed at a timing determined in consideration of the expected life times of the articles installed in the past or at an arbitrary timing. Specifically, the building company may recommend the replacement of household durables, such as a kitchen or bath system, 10 to 20 years after building the new house, or recommend the addition of a photovoltaic generation installation to the customer at an arbitrary timing.

A building management system is disclosed that notifies a building company of the expiration of service lives of housing equipment and prepares a renovation plan (refer to Japanese Unexamined Patent Application Publication No. 2003-223482).

A customer who has cancelled the purchase of a product at the last minute has a high probability of purchasing the same product in the future, regardless of the service lives of other products that have already been purchased by the customer. Unfortunately, a conventional building management system cannot recommend a particular product to a customer who has a high probability of purchasing the product on the basis of factors other than service life.

### SUMMARY OF THE INVENTION

An object of the present invention is to recommend a particular product or service to a customer who has a high probability of purchasing the product or service.

An information processing device according to the present invention includes: a first extracting unit which compares a first list of a product or service created for a customer before purchase and a second list of a product or service purchased by the customer, and guesses and extracts a product or service which the customer has a potential desire to purchase; and a creating unit which creates a third list including the extracted product or service.

A non-transitory computer readable medium according to the present invention is a medium storing a program to allow the computer of an information processing device to execute the steps of: comparing a first list of a product or service created for a customer before purchase and a second list of a product or service purchased by the customer, and guessing and extracting a product or service which the customer has a potential desire to purchase; and creating a third list including the product or service extracted for the customer.

According to the present invention, a particular product or service can be recommended to a customer who has a high probability of purchasing the product or service.

### BRIEF DESCRIPTION OF THE DRAWINGS

The above and other objects, advantages and features of the present invention will become more fully understood from the detailed description given hereinbelow and the appended drawings which are given byway of illustration only, and thus are not intended as a definition of the limits of the present invention.

FIG. 1 is a block diagram of a sales support system according to an embodiment of the present invention.

FIG. 2 is a block diagram illustrating the functional configuration of a server.

FIG. 3 is a block diagram illustrating the functional configuration of a portable terminal.

FIG. 4A illustrates the configuration of a product table.

FIG. 4B illustrates the configuration of an estimate detail table and a contract detail table.

FIG. 4C illustrates the configuration of a recommendation candidate product table.

FIG. 4D illustrates the configuration of an after-purchase-sales candidate customer table.

FIG. 5 illustrates a second contract detail table.

FIG. 6 illustrates a third contract detail table.

FIG. 7A illustrates a second estimate detail table.

FIG. 7B illustrates a third estimate detail table.

FIG. 7C illustrates a fourth contract detail table.

FIG. 8A illustrates a fourth estimate detail table.

FIG. 8B illustrates a fifth contract detail table.

FIG. 9 is a flowchart illustrating a process of creating a recommendation candidate product table.

FIG. 10 is a flowchart illustrating a process of adding deleted product information in the process of creating a recommendation candidate product table.

FIG. 11 is a flowchart illustrating a process of adding downgraded product information in the process of creating a recommendation candidate product table.

FIG. 12 is a flowchart illustrating a process of creating an after-purchase-sales candidate customer table.

FIG. 13 is a flowchart illustrating a process of generating information on after-purchase-sales candidate customer in the process of creating an after-purchase-sales candidate customer table.

FIG. 14 is a flowchart illustrating the subsequent steps of the process of generating information on after-purchase-sales candidate customer in FIG. 13.

### DETAILED DESCRIPTION OF THE PREFERRED EMBODIMENT

Embodiments of the present invention will now be described in detail with reference to the accompanying drawings. The present invention should not be limited to the embodiments depicted in these drawings.

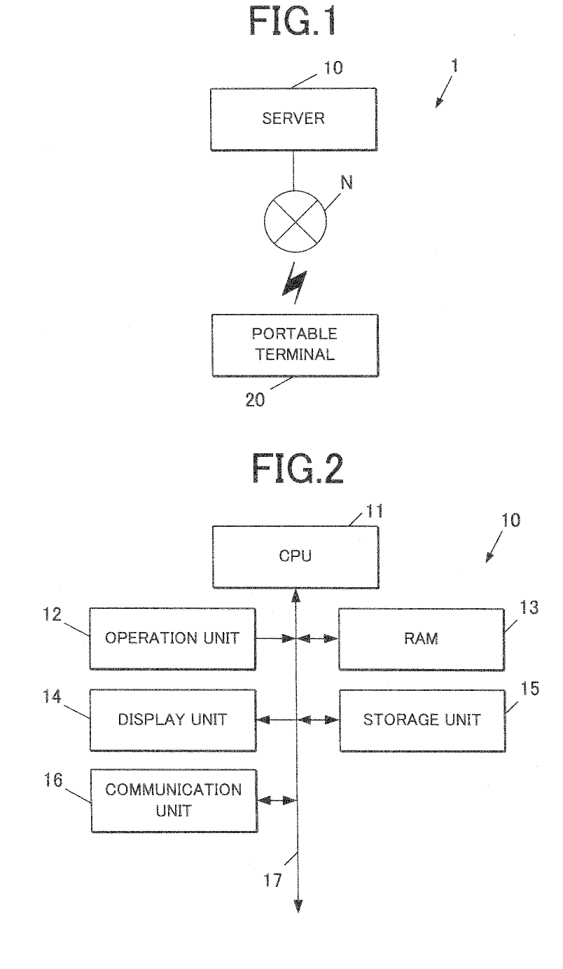

With reference to FIGS. 1 to 3, the configuration of the devices according to an embodiment will be now described. With reference to FIG. 1, a sales support system 1 according to an embodiment will now be described. FIG. 1 is a block diagram illustrating the sales support system 1.

The sales support system 1 provides support for product sales to predetermined building companies, such as building contractor offices that sells and installs products (equipment) for buildings. Specifically, the sales support system 1 supports after-purchase sales for recommending a product to a customer with whom a sales contract was made in the past, the product to be recommended being a product which the customer had contemplated purchasing but finally decided not to purchase at the last sales contract (i.e., a product which the customer decided not to purchase instead of purchasing a downgraded version of the product or a product a downgraded version of which the customer decided to purchase). The sales support system 1 supports after-purchase sales for recommendation of a product which the customer has a potential desire to purchase.

The sales support system 1 includes a server 10 and a portable terminal 20 serving as an information processing device. The devices constituting the sales support system 1 are connected to a communication network N.

The server 10 is a cloud server device on the communication network N and stores and manages information on customers of a building company and business related tasks to be carried out by the building company. The server 10 is constituted of a single device. Alternatively, the server 10 may be constituted of multiple devices.

The portable terminal 20 is owned by a predetermined building company and carried and used by one of the sales persons of the building company. The sales person of the building company may be any employee of the building company, including the chief executive. The portable terminal 20 is a tablet computer that is wirelessly connectable to the communication network N. The portable terminal 20 may be any other portable terminal, for example, a smartphone or a notebook computer. Any sales person can carry the portable terminal 20 to a location, such as the home of a customer or a construction site, outside the office.

The communication network N is the Internet and may include a wide area network (WAN), a local area network (LAN), and/or a dedicated line.

The sales support system 1 includes a single portable terminal 20. Alternatively, the sales support system 1 may include any number of portable terminals 20. The sales support system 1 may include multiple portable terminals 20 owned by different building companies, and the server 10 may manage information items associated with all the building companies. A single building company may own multiple portable terminals 20 in the sales support system 1.

With reference to FIG. 2, the functional configuration of the server 10 will now be described. FIG. 2 is a block diagram illustrating the functional configuration of the server 10.

The server 10 includes a central processing unit (CPU) 11, an operation unit 12, a random access memory (RAM) 13, a display unit 14, a storage unit 15, and a communication unit 16, as illustrated in FIG. 2. The components of the server 10 are connected to each other via a bus 17.

The CPU 11 controls each unit in the server 10. The CPU 11 reads an assigned program from among the system programs and application programs stored in the storage unit 15 and loads the program into the RAM 13 to carry out various processes in cooperation with the loaded program.

The operation unit 12 includes a key input unit, such as a keyboard, and a pointing device, such as a mouse. The operation unit 12 receives key input and positional input and sends the corresponding information to the CPU 11.

The RAM 13 is a volatile memory and provides a work area for various data items and programs to be temporarily stored therein. The display unit 14 is constituted of a liquid crystal display (LCD) or an electroluminescent (EL) display and displays various information items in accordance with instructions from the CPU 11.

The storage unit 15 includes a hard disk drive (HDD) or a solid state drive (SSD). Data and programs can be read from and written onto the storage unit 15. The storage unit 15 stores a product table 30, an estimate detail table 40, a contract detail table 50, a recommendation candidate product table 60, and an after-purchase-sales candidate customer table 70, which are described below.

The communication unit 16 includes a network card and other components and is connected to the communication network N via wired communication. The CPU 11 can communicate with devices on the communication network N via the communication unit 16.

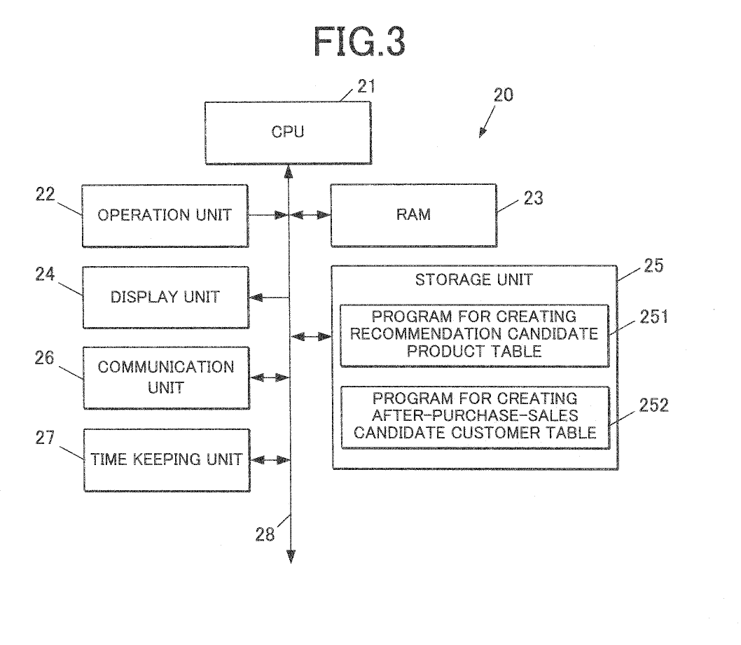

With reference to FIG. 3, the functional configuration of the portable terminal 20 will now be described. FIG. 3 is a block diagram illustrating the functional configuration of the portable terminal 20.

The portable terminal 20 includes a CPU 21 serving as a first extracting unit, a creating unit, a second extracting unit, and a sorting unit; an operation unit 22; a RAM 23; a display unit 24 serving as an output unit; a storage unit 25; a communication unit 26; and a time keeping unit 27. The components of the portable terminal 20 are connected to each other via a bus 28.

The CPU 21, the RAM 23, and the display unit 24 have the same configurations as the CPU 11, the RAM 13, and the display unit 14, respectively, of the server 10. Thus, redundant descriptions of these components are omitted. The CPU 21 controls the components of the portable terminal 20.

The operation unit 22 is a capacitance touch panel disposed on the screen of the display unit 24. The operation unit 22 receives input by a finger of a user touching the screen and sends information in response to the operation to the CPU 21. Alternatively, the operation unit 22 may receive input via a “touch pen” (digitizer pen).

The storage unit 25 includes a flash memory, an electrically erasable programmable read only memory (EEPROM) or the like, from which and onto which information can be read and written. The storage unit 25 stores a program 251 for creating recommendation candidate product table and a program 252 for creating after-purchase-sales candidate customer table.

The communication unit 26 includes a wireless communication unit including an antenna, modulator-demodulator circuit, a signal processor, and other components. The communication unit 26 wirelessly communicates with bases (not shown) or access points (not shown) on the communication network N. The CPU 21 can communicate with devices on the communication network N via the communication unit 26.

The time keeping unit 27 is a real-time clock that counts the current date and time and outputs information on the current date and time to the CPU 21.

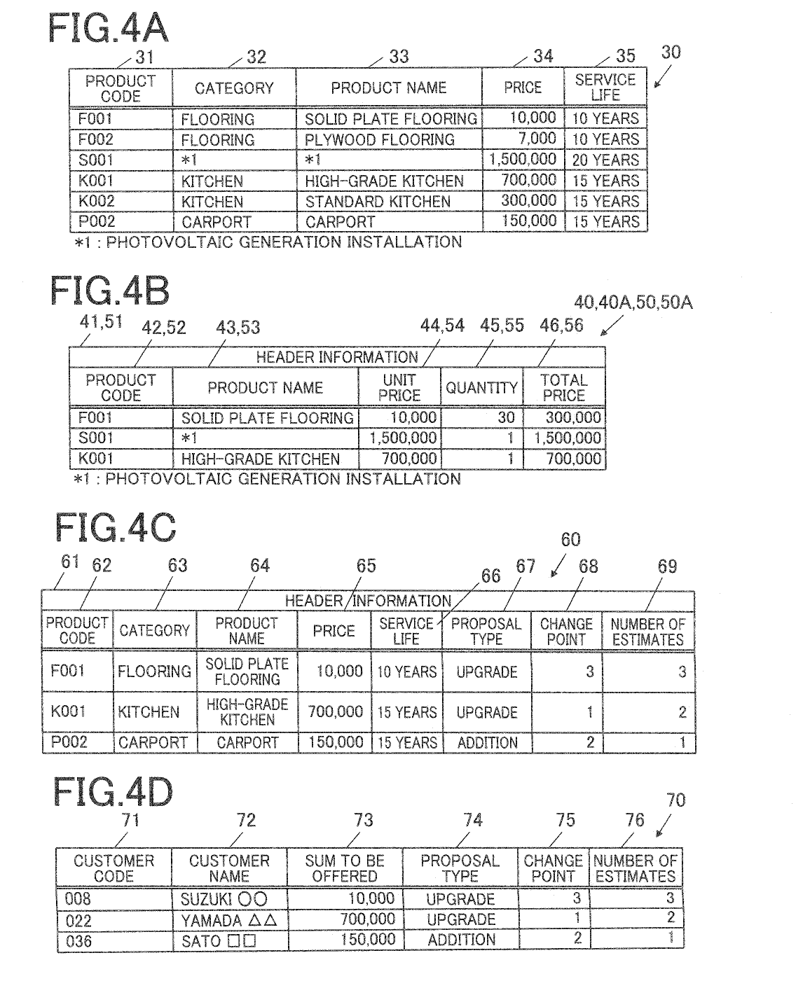

With reference to FIGS. 4A to 4D, the information stored in the server 10 will now be described.

FIG. 4A illustrates the configuration of the product table 30.

FIG. 4B illustrates the configuration of the estimate detail table 40 and the contract detail table 50.

FIG. 4C illustrates the configuration of the recommendation candidate product table 60.

FIG. 4D illustrates the configuration of the after-purchase-sales candidate customer table 70.

With reference to FIG. 4A, the product table 30 stored in the storage unit 15 of the server 10 will now be described.

The product table 30 contains information on all the products (building equipment) handled by the building company. The product table 30 is updated when necessary in response to, for example, a change of a product price. The product table 30 contains fields of product code 31, category 32, product name 33, price 34, and service life 35.

The field of product code 31 contains unique identification information on products. The field of category 32 contains the categories of the products in the field of product code 31. The field of product name 33 contains the names of the products in the field of product code 31. The field of price 34 contains the prices of the products in the field of product code 31. The field of service life 35 contains the service lives of the products in the field of product code 31.

With reference to FIG. 4B, the estimate detail table 40 stored in the storage unit 15 will now be described.

The estimate detail table 40 contains specific information on an estimate created for a customer. The estimate detail table 40 contains fields of header information 41, product code 42, product name 43, unit price 44, quantity 45, and total price 46.

The field of header information 41 contains information associated with an estimate, the information including a unique customer code for the customer who placed the request for the price estimation, the customer name, a business code, and the date of the estimation. The business code is a unique code assigned to a series of business transaction from providing an estimation to signing of a sales contract. The same code is used for the estimates and contracts through the same business transaction.

The field of product code 42 contains the codes of the products in the estimate. The field of product name 43 contains the product names of the products in the field of product code 42. The field of unit price 44 contains the unit prices of the products in the field of product code 42. The field of quantity 45 contains the quantities of the products in the field of product code 42. The field of total price 46 contains the total prices of the products in the field of product code 42 (each of which is determined by multiplying a value in the field of unit price 44 with the corresponding value in the field of quantity 45).

With reference to FIG. 4B, the contract detail table 50 stored in the storage unit 15 will now be described.

The contract detail table 50 contains specific information on a contract for a customer. The contract detail table 50 contains fields of header information 51, product code 52, product name 53, unit price 54, quantity 55, and total price 56.

The field of header information 51 contains information on a contract, the information including a customer code of the customer who signed the contract, the customer name, the business code, the date of the contract, and the completion dates of installation works for the products. The field of product code 52 contains the product codes of the products in the contract. The field of product name 53 contains the names of the products in the field of product code 52. The field of unit price 54 contains the unit prices of the products in the field of product code 52. The field of quantity 55 contains the quantities of the products in the field of product code 52. The field of total price 56 contains the total prices of the products in the field of product code 52 (each of which is determined by multiplying a value in the field of unit price 54 with the corresponding value in the field of quantity 55).

The estimate detail table 40 and the contract detail table 50 specifically containing the records illustrated in FIG. 4B are referred to as an estimate detail table 40A and a contract detail table 50A, respectively. The estimate detail table 40 and the contract detail table 50 can be created in response to a user operation on the portable terminal 20 via the operation unit 22 and uploaded to the server 10 (i.e., the storage unit 15) via the communication unit 26.

With reference to FIG. 4C, the recommendation candidate product table 60 stored in the storage unit 15 will now be described.

The recommendation candidate product table 60 is a table for each customer and contains information on candidate products to be recommended to the customer. The recommendation candidate product table 60 contains fields of header information 61, product code 62, category 63, product name 64, price 65, service life 66, proposal type 67, change point 68, and number of estimates 69.

The field of header information 61 contains information on the products to be recommended, the information including the customer code of the customer to whom recommendations are to be made, the customer name, the date of the contract, and the completion dates of installation works for the products. The field of product code 62 contains product codes of products to be recommended. The field of category 63 contains the categories of the products in the field of product code 62. The field of product name 64 contains the names of the products in the field of product code 62. The field of price 65 contains the prices of the products in the field of product code 62. The field of service life 66 contains the service lives of the products in the field of product code 62. The field of proposal type 67 contains the proposal types for the products in the field of product code 62. The proposal type of each product is set to “upgrade” or “addition” as described below.

The field of change point 68 contains change points set for the recommendation products in the field of product code 62. As described below, a change point is set for a product which is included in an estimate but is not included in a contract as a result of deletion, or to a product which is included in an estimate and a downgraded version of which is included in a contract as a result of downgrade. A value “3”, “2”, or “1” is set as the change point of such a product depending on the position (point) of the deletion or the downgrade relative to the position (point) of the creation of the contract. The field of number of estimates 69 contains the numbers of estimates created for the recommendation products in the field of product code 62. As described below, a value “1”, “2”, or “3” (where 3 is the maximum value) is set for a recommendation product which was included in an estimate(s) but was finally deleted or downgraded at a contract, depending on the number of estimates in which the product was included. The values are mere examples, and any value other than 1 to 3 may be set as the number of estimates.

With reference to FIG. 4D, the after-purchase-sales candidate customer table 70 stored in the storage unit 15 will now be described. The after-purchase-sales candidate customer table 70 contains information on customers to whom products are to be recommended after signing of contracts for products or after installation work for products through after-purchase sales. The after-purchase-sales candidate customer table 70 contains fields of customer code 71, customer name 72, sum of money 73, proposal type 74, change point 75, and number of estimates 76.

The field of customer code 71 contains unique identification information of customers. The field of customer name 72 contains the names of the customers in the field of customer code 71. The field of sum of money 73 contains the sums of money for products to be recommended to the customers in the field of customer code 71 through after-purchase sales. The field of proposal type 74 contains the proposal types for the products to be recommended through after-purchase sales to the customers in the field of customer code 71. The field of change point 75 contains the change points set for the products to be recommended through after-purchase sales to the customers in the field of customer code 71. The field of number of estimates 76 contains the numbers of estimates including the products to be recommended to the customers in the field of customer code 71 through after-purchase sales.

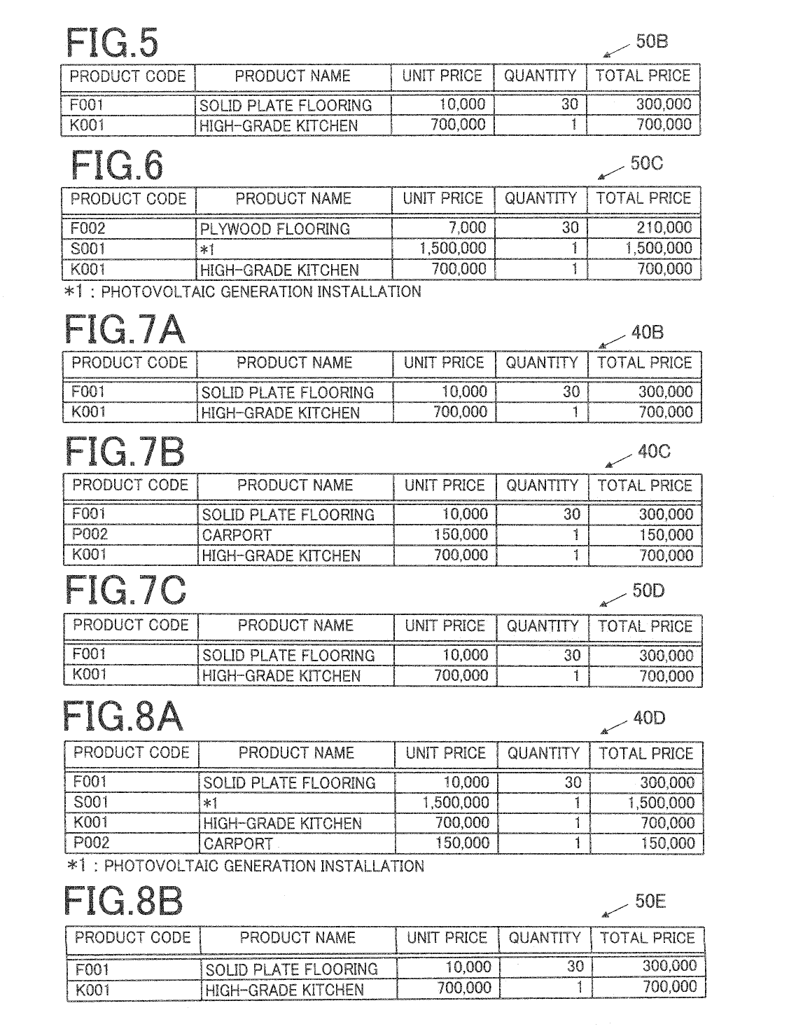

With reference to FIGS. 5 to 8B, different examples of extracted recommendation products will now be described.

FIG. 5 illustrates a contract detail table 50B.

FIG. 6 illustrates a contract detail table 50C.

FIG. 7A illustrates an estimate detail table 40B.

FIG. 7B illustrates an estimate detail table 40C.

FIG. 7C illustrates a contract detail table 50D.

FIG. 8A illustrates an estimate detail table 40D.

FIG. 8B illustrates a contract detail table 50E.

An example process of recommending a product that was deleted during a business transaction of products will now be described. During a business transaction, an estimate corresponding to the estimate detail table 40A illustrated in FIG. 4B is created and sent to a customer, and finally a contract corresponding to the contract detail table 50B illustrated in FIG. 5 is signed by the customer.

A record of a product having a product name “photovoltaic generation installation” is included in the estimate detail table 40A but is not included in the contract detail table 50B. The portable terminal 20 guesses, from this deletion, that the customer had a desire to purchase a photovoltaic generation installation at the time of creation of the estimate but gave up the desire by the time of signing the contract for the reason of budget or other issues. Thus, this customer can be extracted as a potential buyer. The portable terminal 20 guesses that the photovoltaic generation installation is a product which the customer has a potential desire to purchase and extracts the photovoltaic generation installation. Thus, a sales person should recommend the photovoltaic generation installation to the extracted customer through after-purchase sales because the purchase conditions may be favorable for the customer now.

An example process of recommending a product to a customer, who had contemplated the purchase of the product but actually purchased a downgraded version of the product, will now be described.

During a business transaction, an estimate corresponding to the estimate detail table 40A illustrated in FIG. 4B is created and sent to a customer, and finally a contract corresponding to the contract detail table 50C illustrated in FIG. 6 is signed by the customer.

The estimate detail table 40A includes a record of a product named “solid plate flooring”, whereas the contract detail table 50C includes a record of a product named “plywood flooring”, which is a downgraded version of the “solid plate flooring.”

Downgrading of a product is, for example, determined on the basis of replacement of a product with another product with a lower unit price in the same category.

The portable terminal 20 guesses, from this replacement, that the customer had a desire to purchase the solid plate flooring at time of creation of an estimate but gave up the desire by the time of signing the contract for the reason of budget or other issues and purchased the plywood flooring instead. Thus, this customer can be extracted as a potential buyer. Thus, a sales person should recommend the solid plate flooring, an upgraded version, to the extracted customer through after-purchase sales because the purchase conditions may be favorable for the customer now.

An example process of preferentially recommending a product of which the purchase was canceled most recently will now be described.

During the business transaction, an estimate corresponding to the estimate detail table 40A illustrated in FIG. 4B is created and sent to the customer. The estimate is sequentially updated to the one corresponding to the estimate detail table 40B illustrated in FIG. 7A and the one corresponding to the estimate detail table 40C illustrated in FIG. 7B. Finally, a contract corresponding to the contract detail table 50D illustrated in FIG. 7C is signed by the customer.

A record of a product named “photovoltaic generation installation” is included in the estimate detail table 40A but is not included in the estimate detail table 40B.

Furthermore, the estimate detail table 40B does not include a record of a product named “carport” but the estimate detail table 40C includes this record. The record of “carport” is included in the estimate detail table 40C but is not included in the contract detail table 50D.

Although both the photovoltaic generation installation and the carport were deleted during sales negotiation, a sales person should preferentially recommend the carport through after-purchase sales because it is deleted more recently, i.e., at the time of the creation of the contract detail table 50D, than the photovoltaic generation installation. The customer contemplated the purchase of the carport nearly until signing the sales contract. A product that has been most recently downgraded is to be also preferentially recommended.

An example process of preferentially recommending a product included in a larger number of estimates will now be described.

During the business transaction, an estimate corresponding to the estimate detail table 40A illustrated in FIG. 4B is created and sent to the customer. The estimate is updated to the one corresponding to the estimate detail table 40D illustrated in FIG. 8A, and finally, a contract corresponding to the contract detail table 50E illustrated in FIG. 8B is signed by the customer.

The estimate detail table 40A does not include a record of a product named “carport” but the estimate detail table 40D includes this record. Furthermore, the estimate detail table 40D includes records of products named “photovoltaic generation installation” and “carport” but the contract detail table 50E does not include these records.

Although both the photovoltaic generation installation and the carport were deleted during sales negotiation, a sales person should preferentially recommend through after-purchase sales the photovoltaic generation installation whose record is included in two estimates, compared to the carport whose record is included in only one estimate. The customer contemplated the purchase of the photovoltaic generation installation for a longer time before signing the sales contract. A product included in a larger number of estimates but finally downgraded is to be also preferentially recommended.

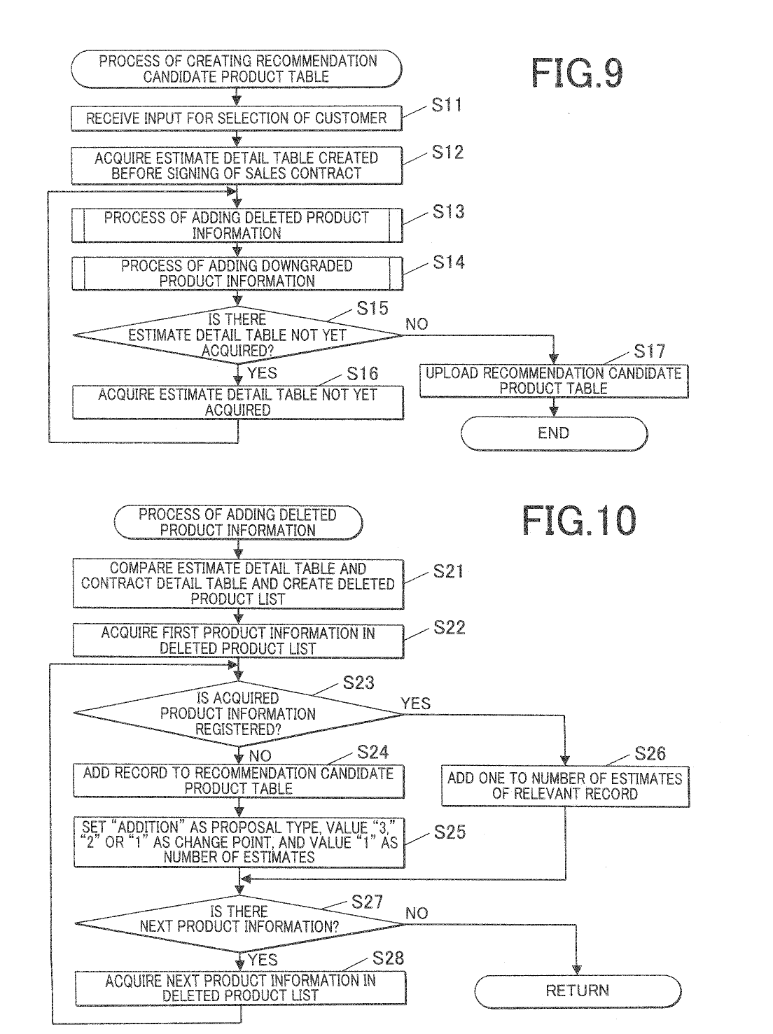

With reference to FIGS. 9 to 14, the operation of the sales support system 1 will now be described.

FIG. 9 is a flowchart illustrating the process of creating a recommendation candidate product table.

FIG. 10 is a flowchart illustrating a process of adding deleted product information in the process of creating a recommendation candidate product table.

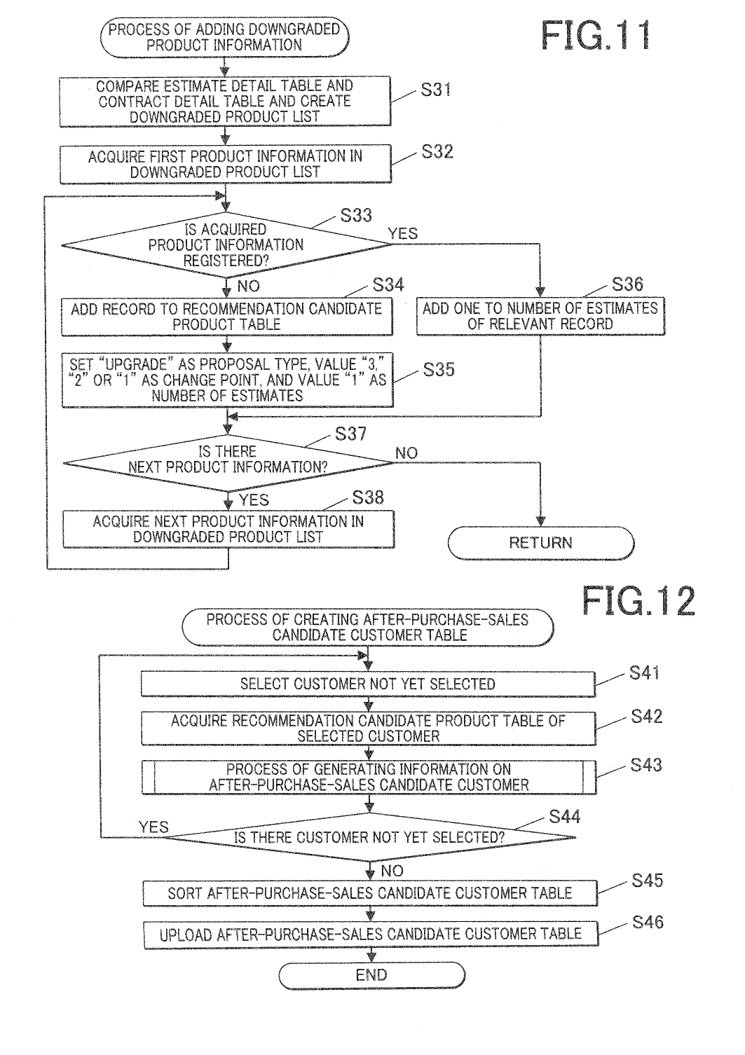

FIG. 11 is a flowchart illustrating a process of adding downgraded product information in the process of creating a recommendation candidate product table.

FIG. 12 is a flowchart illustrating a process of creating an after-purchase-sales candidate customer table.

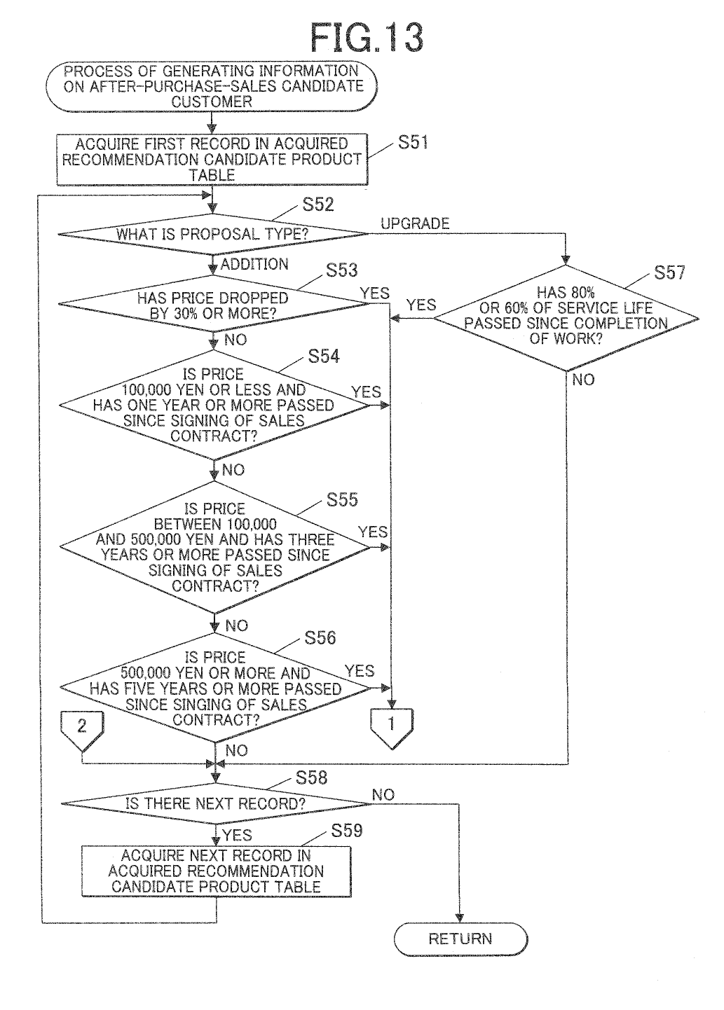

FIG. 13 is a flowchart illustrating a process of generating information on after-purchase-sales candidate customer in the process of creating an after-purchase-sales candidate customer table.

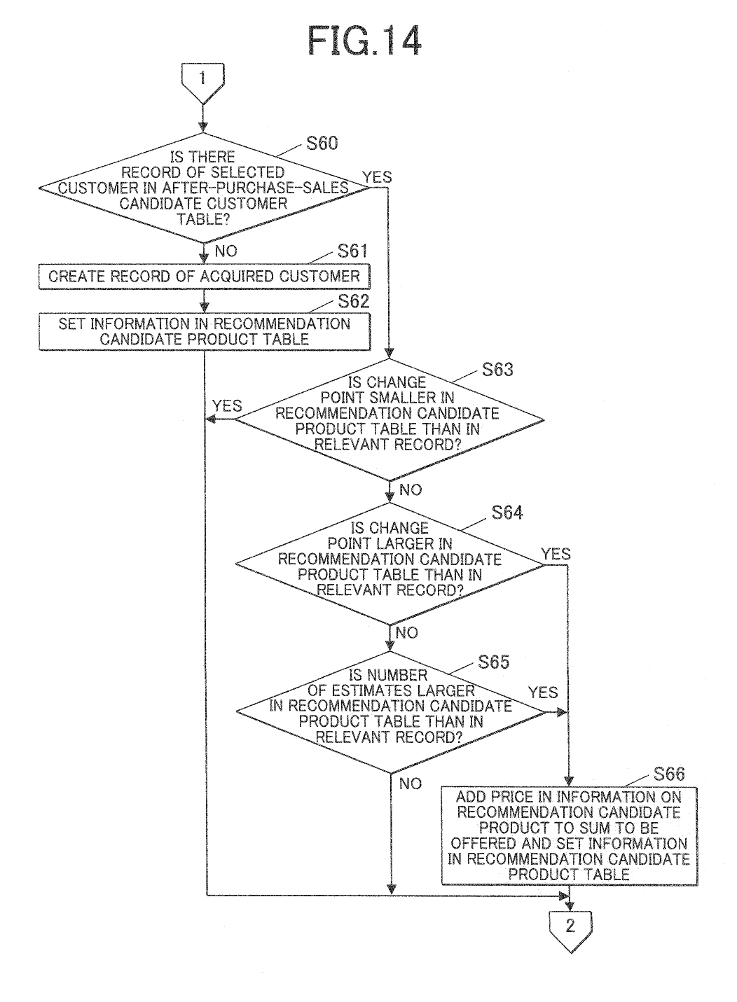

FIG. 14 is a flowchart illustrating the subsequent steps of the process of generating information on after-purchase-sales candidate customer in FIG. 13.

With reference to FIGS. 9 to 11, the process of creating a recommendation candidate product table carried out by the portable terminal 20 will now be described. The CPU 21 carries out the process of creating a recommendation candidate product table in cooperation with the program 251 for creating recommendation candidate product table read from the storage unit 25 and loaded to the RAM 23, in response to a user's (or a sales person's) instruction input for the start of this process to the portable terminal 20 via the operation unit 22 as a trigger.

With reference to FIG. 9, the CPU 21 receives an input from a user via the operation unit 22 for selection of a target customer for whom a recommendation candidate product table is to be created (Step S11).

The CPU 21 downloads and acquires, from the server 10 (i.e., storage unit 15) via the communication unit 26, an estimate detail table 40 that corresponds to an estimate created before signing of the sales contract and includes header information 41 containing customer information on the customer selected in Step S11 (Step S12).

The CPU 21 carries out a process of adding deleted product information (Step S13), which is described below. The CPU 21 then carries out a process of adding downgraded product information (Step S14), which is described below.

The CPU 21 determines whether an estimate detail table 40 corresponding to an estimate not acquired in Steps S12 and S16 is stored in the server 10 (i.e., storage unit 15) (Step S15).

If such an estimate detail table 40 not yet acquired is stored (YES in Step S15), the CPU 21 downloads and acquires, from the server 10 (i.e., storage unit 15) via the communication unit 26, the estimate detail table 40 of an estimate not yet acquired and including header information 41 containing the customer information on the customer selected in Step S11 (Step S16). The process then goes to Step S13.

If no estimate detail table 40 not yet acquired is stored (NO in Step S15), the CPU 21 adds the contract date and the completion date of the installation work, through the communication unit 26, to the header information 61 of the recommendation candidate product table 60 created in Steps S13 and S14, and stores the modified recommendation candidate product table 60 in the server 10 (i.e., storage unit 15) (Step S17). The process then ends.

With reference to FIG. 10, the process of adding deleted product information in Step S13 in the process of creating a recommendation candidate product table illustrated in FIG. 9 will now be described.

The CPU 21 downloads, from the server 10 (i.e., storage unit 15) via the communication unit 26, a product table 30 and a contract detail table 50 corresponding to the estimate detail table 40 acquired in Step S12 or S16 in FIG. 9, compares the estimate detail table 40 and the contract detail table 50, and creates a list of products which is included in the estimate detail table 40 at the time of estimation but is deleted by the time of signing of a contract and is not included in the contract detail table 50 (deleted product list) (Step S21).

The contract detail table 50 corresponding to the estimate detail table 40 includes header information 51 containing a business code identical to the business code in the header information 41.

The deleted product list includes the product code 42 of the record of each product included in the acquired estimate detail table 40 but deleted later, and the category 32, the product name 33, the price 34, and the service life 35 of the product table 30 having the product code 31 corresponding to the product code 42.

The CPU 21 acquires the first product information (first record) in the deleted product list created in Step S21 (Step 922).

The CPU 21 determines whether the product information acquired in Step S22 or S28 is already registered in the recommendation candidate product table 60 for the customer input in Step S11 illustrated in FIG. 9 (Step S23).

The recommendation candidate product table 60 for the customer input in Step S11 includes header information 61 containing the customer code and the customer name of the customer input in Step S11 illustrated in FIG. 9.

If the product information is not registered (NO in Step S23), the CPU 21 adds the product information acquired in Step S22 or S28, as a single record containing values of the product code 62, the category 63, the product name 64, the price 65, and the service life 66, to the recommendation candidate product table 60 for the customer input in Step S11 illustrated in FIG. 9 (Step S24).

The CPU 21 sets “addition” as the proposal type 67 of the record added in Step S24, sets a value “3”, “2”, or “1” as the change point 68 depending on the position of the estimate corresponding to the estimate detail table 40 acquired in Step 12 or 16 relative to the time of the creation of the contract (“3” for most recent, “2” for second most recent, and “1” for third most recent or less recent), and sets the value “1” as the number of estimates 69 (Step S25).

If the product information is already registered (YES in Step S23), the CPU 21 adds one to the number of estimates 69 of the record of the registered product in the recommendation candidate product table 60 for the customer input in Step S11 (Step S26). The maximum value for the number of estimates 69 is “3” in this embodiment.

The CPU 21 determines whether the deleted product list created in Step S21 contains the next product information not yet acquired (Step S27).

If the next product information remains (YES in Step S27), the CPU 21 acquires the next product information in the deleted product list created in Step S21 (Step S28). The process then goes to Step S23.

If no next product information remains (NO in Step S27), the CPU 21 ends the process.

With reference to FIG. 11, the process of adding downgraded product information in Step S14 in the process of creating recommendation candidate product table illustrated in FIG. 9 will now be described.

The CPU 21 compares the estimate detail table 40 acquired in Step S12 or S16 illustrated in FIG. 9 and the corresponding contract detail table 50 via the communication unit 26, and creates a list of products downgraded at the contract detail table 50 compared to the estimate detail table 40 for estimation (downgraded product list) (Step S31).

The downgraded product list includes the product code 42 of the record of each product included in the acquired estimate detail table 40 but downgraded later, and the category 32, the product name 33, the price 34, and the service life 35 of the product table 30 having the product code 31 corresponding to the product code 42. The term “downgraded product” refers to a downgraded version of an original product whose category 32 is the same as that of the original product but whose price 34 is lower than that of the original product.

The CPU 21 acquires the first product information (first record) in the downgraded product list created in Step S31 (Step S32). The CPU 21 determines whether the product information acquired in Step S32 or S38 is already registered in the recommendation candidate product table 60 for the customer input in Step S11 illustrated in FIG. 9 (Step S33).

If the product information is not registered (NO in Step S33), the CPU 21 adds the product information acquired in Step S32 or S38, as a single record containing values of the product code 62, the category 63, the product name 64, the price 65, and the service life 66, to the recommendation candidate product table 60 for the customer input in Step S11 (Step S34).

The CPU 21 sets “upgrade” as the proposal type 67 of the record added in Step S34, sets a value “3”, “2”, or “1” as the change point 68 depending on the position of the estimate corresponding to the estimate detail table 40 acquired in Step 12 or 16 illustrated in FIG. 9 relative to the time of the creation of the contract (“3” for most recent, “2” for second most recent, and “1” for third most recent or less recent), and sets the value “1” as the number of estimates 69 (Step S35).

If the product information is already registered (YES in Step S33), the CPU 21 adds one to the value (of which the maximum is three) of the number of estimates 69 of the record of the registered product in the recommendation candidate product table 60 for the customer input in Step S11 illustrated in FIG. 9 (Step S36).

The CPU 21 determines whether the downgraded product list created in Step S31 contains the next product information that has not yet been acquired (Step S37).

If the next product information is contained (YES in Step S37), the CPU 21 acquires the next product information from the downgraded product list created in Step S31 (Step S38). The process then goes to Step S33.

If no next product information is contained (NO in Step S37), the CPU 21 ends the process.

With reference to FIGS. 12 to 14, the process of creating an after-purchase-sales candidate customer table carried out by the portable terminal 20 will now be described.

The CPU 21 carries out the process of creating an after-purchase-sales candidate customer table in cooperation with the program 252 for creating after-purchase-sales candidate customer table read from the storage unit 25 and loaded to the RAM 23, in response to a user's (or a sales person's) instruction input for the start of this process to the portable terminal 20 via the operation unit 22 as a trigger.

With reference to FIG. 12, the CPU 21 downloads, from the server 10 (i.e., storage unit 15) via the communication unit 26, recommendation candidate product tables 60 corresponding to recommendation candidate products for all customers. The CPU 21 refers to the header information 61 of the downloaded recommendation candidate product tables 60 and selects a customer that has not yet been selected among the customers corresponding to all the customer codes (Step S41).

The CPU 21 acquires the recommendation candidate product table 60 for the customer selected in Step S41 (Step S42).

The CPU 21 carries out the process of generating information on after-purchase-sales candidate customer (Step S43), which will be described below.

With reference to FIGS. 13 and 14 and Step S43, the process of generating information on after-purchase-sales candidate customer will now be described.

With reference to FIG. 13, the CPU 21 acquires the first record of the recommendation candidate product table 60 acquired in Step S42 illustrated in FIG. 12, the record containing the product code 62, the category 63, the product name 64, the price 65, the service life 66, the proposal type 67, the change point 68, and the number of estimates 69 (Step S51).

The CPU 21 determines whether the proposal type 67 of the record acquired in Step S51 or S59 is “addition” or “upgrade” (Step S52).

If the proposal type 67 is “addition” (ADDITION in Step S52), the CPU 21 downloads the current product table 30 from the server 10 (i.e., storage unit 15) via the communication unit 26, and determines whether the current price (the price 34) of the same product (the product codes 62 and 31) has dropped by 30% or more from the price 65 of the record acquired in Step S51 or S59 (Step S53).

In Step S53, the determination is made based on whether the current price 34 is 30% or more less than the original price due to a price change of the product. In addition, the determination is made based on whether the current price 34 to be actually paid is 30% or more less than the original price if the price to be actually paid is less due to subsidization.

If the price 34 has not currently dropped by 30% or more (NO in Step S53), the CPU 21 refers to the header information 61 of the recommendation candidate product table 60 acquired in Step S41 illustrated in FIG. 12, acquires information on the current date from the time keeping unit 27, and determines whether the price 65 of the record acquired in Step S51 or S59 is 100,000 Yen or less and whether one year or more has passed since the contract date in the header information 61 up to the current date (Step S54).

If the price 65 is not 100,000 Yen and/or one year or more has not passed (NO in Step S54), the CPU 21 refers to the header information 61 of the recommendation candidate product table 60 acquired in Step S41 illustrated in FIG. 12, and determines whether the price 65 of the record acquired in Step S51 or S59 is between 100,000 and 500,000 Yen and whether three years or more has passed since the contract date up to the current date (Step S55).

If the price 65 is not between 100,000 and 500,000 Yen and/or three years or more has not passed (NO in Step S55), the CPU 21 refers to the header information 61 of the recommendation candidate product table 60 acquired in Step S41 illustrated in FIG. 12, and determines whether the price 65 of the record acquired in Step S51 or S59 is 500,000 Yen or more and whether five years or more has passed since the contract date in the header information 61 up to the current date (Step S56).

If the price 65 is not 500,000 Yen or more and/or five years or more has not passed (NO in Step S56), the CPU 21 determines whether the recommendation candidate product table 60 acquired in Step S42 illustrated in FIG. 12 includes a next record that has not yet been selected (Step S58).

If a next record is included (YES in Step S58), the CPU 21 acquires the next record that has not yet been selected in the recommendation candidate product table 60 acquired in Step S42 (Step S59). The process then goes to Step S52.

If no next record is included (NO in Step S58), the CPU 21 ends the process.

If “upgrade” is set (UPGRADE in Step S52), the CPU 21 downloads the current product table 30 from the server 10 (i.e., storage unit 15) via the communication unit 26, refers to the header information 61 of the recommendation candidate product table 60 acquired in Step S41, acquires information on the current date from the time keeping unit 27, and determines whether the price 34 of the product corresponding to the product codes 62 and 31 has currently dropped by 30% or more from the price 65 of the record acquired in Step S51 or S59.

If the price 34 has not dropped by 30% or more, the CPU 21 determines whether 80% of the service life 66 of the acquired record has passed since the work completion date in the header information 61 on the basis of the information on the current date. If the price 34 has dropped by 30% or more, the CPU 21 determines whether 60% of the service life 66 has passed since the work completion date on the basis of the information on the current date (Step S57).

If 80% or 60% of the service life 66 has not passed (NO in Step S57), the process goes to Step S58.

The process goes to Step S60 illustrated in FIG. 14 in the following cases: the price 34 has currently dropped by 30% or more (YES in Step S53); the price 65 is 100,000 Yen or less and one year or more has passed (YES in Step S54); the price 65 is between 100,000 and 500,000 Yen and three years or more has passed (YES in Step S55); the price 65 is 500,000 Yen or more and five years or more has passed (YES in Step S56); and 80% or 60% of the service life 66 has passed (YES in Step S57).

With reference to FIG. 14, the CPU 21 determines whether the after-purchase-sales candidate customer table 70 that is being created contains a record for the customer selected in Step S41 (Step S60).

If no record for the customer is contained (NO in Step S60), the CPU 21 refers to the header information 61 of the recommendation candidate product table 60 acquired in Step S41, and creates a record in the after-purchase-sales candidate customer table 70, the record including the customer code and the customer name of the header information 61 as a customer code 71 and a customer name 72 (Step S61).

The CPU 21 sets the price 65, the proposal type 67, the change point 68, and the number of estimates 69 of the record acquired in Step S51 or S59 illustrated in FIG. 13 as the sum of money 73, the proposal type 74, the change point 75, and the number of estimates 76, respectively, of the record created in Step S61 (Step S62). The process then goes to Step S58 illustrated in FIG. 13.

If there is record for the customer (YES in Step S60), the CPU 21 determines whether the change point 68 of the record acquired in Step S51 or S59 illustrated in FIG. 13 is smaller than the change point 75 of the record of the customer in the after-purchase-sales candidate customer table 70 (Step S63).

If the change point 68 is smaller than the change point 75 (YES in Step S63), the process goes to Step S58 illustrated in FIG. 13. If the change point 68 is not smaller than the change point 75 (NO in Step S63), the CPU 21 determines whether the change point 68 in the record acquired in Step S51 or S59 illustrated in FIG. 13 is larger than the change point 75 in the record for the customer in the after-purchase-sales candidate customer table 70 (Step S64).

If the change point 75 and the change point 68 are the same (NO in Step S64), the CPU 21 determine whether the number of estimates 69 of the record acquired in Step S51 or 959 is larger than the number of estimates 76 of the record for the customer in the after-purchase-sales candidate customer table 70 (Step S65).

If the number of estimates 69 is not larger than the number of estimates 76 (NO in Step S65), the process goes to Step S58 illustrated in FIG. 13.

If the change point 68 is larger than the change point 75 (YES in Step S64) or if the number of estimates 69 is larger than the number of estimates 76 (YES in Step S65), the CPU 21 adds the value of the price 65 of the record acquired in Step S51 or S59 illustrated in FIG. 13 to the sum of money 73 of the record for the customer in the after-purchase-sales candidate customer table 70, and sets the proposal type 67, the change point 68, and the number of estimates 69 in the record as the proposal type 74, the change point 75, and the number of estimates 76, respectively, in the record for the customer in the after-purchase-sales candidate customer table 70 (Step S66) The process then goes to Step S58 illustrated in FIG. 13.

Referring back to FIG. 12, after Step S43, the CPU 21 determines whether there is a customer that has not yet been selected in Step S41 (Step S44).

If there is a customer that has not yet been selected (YES in Step S44), the process goes to Step S41.

If there are no customers that has not yet been selected (NO in Step S44), the CPU 21 sorts the records in the after-purchase-sales candidate customer table 70 generated in Step S43 by the change point 75, the number of estimates 76, and the sum of money 73 (Step S45).

In Step S45, the records in the after-purchase-sales candidate customer table 70 are sorted in a descending order of the total value of the change point 75 and the number of estimates 76. Records having the same total value are sorted in descending order of the sum of money 73.

The CPU 21 uploads the after-purchase-sales candidate customer table 70 sorted in Step S45 in the server 10 (i.e., storage unit 15) for the table 70 to be stored therein (Step S46), and ends the process.

After completing the process of creating recommendation candidate product table and the process of creating after-purchase-sales candidate customer table, the CPU 21 carries out the process of displaying tables in cooperation with a table display program (not shown) read from the storage unit 25 and loaded to the RAM 23, in response to a user's (or a sales person's) instruction input for the start of this process to the portable terminal 20 via the operation unit 22 as a trigger.

In the table display process, the CPU 21 downloads the recommendation candidate product table 60 and the after-purchase-sales candidate customer table 70 from the server 10 (i.e., storage unit 15) and displays these tables on the display unit 24.

According to the embodiment described above, the portable terminal 20 compares the estimate detail table 40 of products created for a customer before the purchase and the contract detail table 50 including the products purchased by the customer, guesses and extracts products which the customer had contemplated purchasing but finally gave up purchasing, and creates a recommendation candidate product table 60 including the extracted products for each customer. In other words, the portable terminal 20 compares the estimate detail table 40 created before the purchase and the final contract detail table 50 for each customer, guesses and extracts products which the customer has a potential desire to purchase, and creates a recommendation candidate product table 60 including the extracted products for the customer.

In this way, a sales person can refer to the displayed recommendation candidate product table 60 to recommend a particular product to a customer who has a high probability of purchasing the product, and increase the percentage of successful sales and sale proceeds. Unlike a known technique of merely recommending the same products as those purchased in the past based on the service lives of the purchased products, the technique according to an embodiment of the prevent invention can recommend products that the customers did not purchase in the past.

Products whose prices have dropped due to a price change after a passage of time, products whose real prices have dropped due to subsidization, products for which a long time has passed since the close of the contract, and products of which predetermined percentages of the service lives have passed since the completion of works can be recommended based on the process of generating information on after-purchase-sales candidate customer illustrated in FIGS. 13 and 14, leading to increase in percentage of successful sales and sale proceeds.

The portable terminal 20 extracts products which are included in the estimate detail table 40 but are not included in the contract detail table 50 and products which are included in the estimate detail table 40 and downgraded versions of which are included in the contract detail table 50.

A customer who had contemplated the purchase of a particular product together with other products but decided not to purchase the particular product before signing the sales contract for the other products in the past may have an increased probability of purchasing the particular product due to an improvement of financial status or change in mind with a time passage. The customer has a high potential for additionally purchasing such a product. A customer who had contemplated the purchase of a particular product but decided to purchase a downgraded version of the particular product may have an increased probability of purchasing the particular product due to an improvement of financial status or change in mind with a time passage. The customer has a high potential for purchasing the particular product, which is an upgraded version of the already-purchased product. Such products that the customer are likely to purchase can be recommended to the customer.

Since an upgraded version of a product which the customer already purchased has a higher price than the already-purchased product, recommendation of such an upgraded version contributes to increase in sale proceeds. Alternatively, the portable terminal 20 may extract one of (i) products that have been deleted and (ii) products that have been downgraded.

The portable terminal 20 makes the recommendation candidate product table 60 include values of the price 65, the service life 66, the proposal type 67, the change point 68, and the number of estimates 69 of the guessed and extracted products.

Thus, a sales person can refer to the displayed recommendation candidate product table 60 and confirm values of the price 65, the service life 66, the proposal type 67, the Change point 68, and the number of estimates 69 of the guessed and extracted products.

In addition, the portable terminal 20 creates an after-purchase-sales candidate customer table 70 containing the candidate customers to which the guessed and extracted products are to be recommended, the candidate customers in the table 70 being listed in a descending order of purchase probability.

A sales person can refer to the displayed after-purchase-sales candidate customer table 70 and confirm a customer that has a high probability of purchasing a particular product.

A sales person can refer to both the recommendation candidate product table 60 and the after-purchase-sales candidate customer table 70 and recommend a particular product that best suits a customer at the best timing (when the customer has a high probability of purchasing the product).

The portable terminal 20 displays the recommendation candidate product table 60 and the after-purchase-sales candidate customer table 70 on the display unit 24.

Thus, a sales person can view the recommendation candidate product table 60 to readily and surely confirm products that are likely to be purchased by customers and can view the after-purchase-sales candidate customer table 70 to readily and surely confirm customers that have a high probability of purchasing products.

The portable terminal 20 extracts products to be sorted from the products that are guessed and extracted, and sorts the after-purchase-sales candidate customer table 70 based on the information on the extracted products.

Thus, products that are likely to be purchased can be extracted for sorting from the products that are guessed and extracted, and customers can be accurately sorted in a descending order of probability of purchase based on the information on products that are likely to be purchased.

The portable terminal 20 determines products to be sorted on the basis of age, service life, price range, and price drop conditions for the guessed and extracted products, and extracts the products to be sorted from the products that are guessed and extracted.

Products that are likely to be purchased can be accurately extracted as products to be sorted on the basis of age, service life, price range, and price drop conditions. Alternatively, the extraction may be based on at least one of the age, service life, price range, and price drop conditions.

The portable terminal 20 sorts the after-purchase-sales candidate customer table 70 on the basis of values of the change point, the number of estimates, and the sum of money for the extracted products.

Thus, the customers can be accurately sorted in a descending order of probability of purchasing the products based on values of the change point, the number of estimates, and the sum of money for the products that are highly likely to be purchased. Alternatively, the sorting may be based on at least one of values of the change point, the numbers of estimate, and the sum of money.

In the embodiments described above, a flash memory or EEPROM serves as a storage unit 25, which is a computer readable medium in which the programs according to the present invention is stored. Alternatively, any computer readable medium may be used.

Other examples of computer readable media include portable recording media, such as HDDs, SSDs, and CD-ROMs. Carrier waves are also used as media for providing program data according to the present invention via communication lines.

The embodiments described above are mere examples, and the information processing device and the computer readable medium according to the present invention should not be limited thereto.

For example, in the embodiments described above, the process of creating recommendation candidate product table and the process of creating after-purchase-sales candidate customer table are carried out at any timing in response to a user instruction. Alternatively, the processes may be carried out at any other timing.

For example, the server 10 may carry out the process of creating recommendation candidate product table and the process of creating after-purchase-sales candidate customer table at a timing corresponding to a revision of a product price or an updating of an estimate detail table 40 or contract detail table 50, and may update the recommendation candidate product table 60 and the after-purchase-sales candidate customer table 70; in response to this, information on products to be recommended to customers in the after-purchase-sales candidate customer table 70 may be transmitted to the portable terminal 20 at an appropriate timing for recommendation and may be displayed on the display unit 24, so as to automatically notify sales persons of information on recommendations of products at appropriate timings.

The information processing device to carry out the process of creating recommendation candidate product table and the process of creating after-purchase-sales candidate customer table may be a desktop computer installed in a building contractor office.

In the embodiments described above, the recommendation candidate product table 60 and the after-purchase-sales candidate customer table 70 created through the process of creating recommendation candidate product table and the process of creating after-purchase-sales candidate customer table, respectively, are displayed at any timing in response to a user instruction. Alternatively, the tables may be displayed at any other timing.

For example, the created recommendation candidate product table 60 and after-purchase-sales candidate customer table 70 may be displayed before the completion of the process of creating recommendation candidate product table and the process of creating after-purchase-sales candidate customer table.

In the embodiments described above, building equipments are the products as the objects of guess and extraction which customers have a potential desire to purchase. Alternatively, any object may be guessed and extracted. Examples of the objects of guess and extraction may include automobiles, other products, or services such as massages.

It should be understood that the plural forms “products”, “customers”, and “estimates” etc. in the embodiments described above include the case of a single “product”, “customer”, and “estimate” etc. For example, there is of course a case in which there is only a single relevant or target product, customer, or estimate etc.

The detailed configuration and operation of the components in the sales support system 1 according to the embodiments described above may be modified in various ways within the scope of the invention.

The present invention should not be limited to the embodiments described above, and the claims and equivalents thereof are included in the scope of the invention.

The entire disclosure of Japanese Patent Application No. 2014-173412 filed on Aug. 28, 2014 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An information processing device comprising:
a first extracting unit which compares a first list of a product or service created for a customer before purchase and a second list of a product or service purchased by the customer, and guesses and extracts a product or service which the customer has a potential desire to purchase; and
a creating unit which creates a third list including the extracted product or service.

2. The information processing device according to claim 1, wherein the first extracting unit guesses and extracts at least one of (i) the product or service which is included in the first list but is not included in the second list and (ii) the product or service which is included in the first list and a downgraded version of which is included in the second list.

3. The information processing device according to claim 1, wherein the creating unit makes the third list include at least one of a price of the extracted product or service, a service life of the extracted product or service, a proposal type of the extracted product or service, a change point of the first list from the second list with respect to the extracted product or service, and the number of the first list including the extracted product or service.

4. The information processing device according to claim 1, wherein the creating unit creates a fourth list including a candidate customer to whom the extracted product or service is to be recommended, the candidate customer in the fourth list being listed in a descending order of probability of purchasing the extracted product or service.

5. The information processing device according to claim 4, further comprising:
an output unit which outputs the third list and the fourth list.

6. The information processing device according to claim 4, further comprising:
a second extracting unit which extracts a product or service to be sorted from the product or service extracted by the first extracting unit; and
a sorting unit which sorts the fourth list on the basis of information on the product or service extracted by the second extracting unit.

7. The information processing device according to claim 6, wherein the second extracting unit determines the product or service to be sorted on the basis of at least one of an age, a service life, a price range, and a price drop of the product or service extracted by the first extracting unit, and extracts the determined product or service from the product or service extracted by the first extracting unit.

8. The information processing device according to claim 6, wherein the sorting unit sorts the fourth list on the basis of at least one of a change point of the first list from the second list with respect to the product or service extracted by the second extracting unit, the number of the first list including the product or service extracted by the second extracting unit, and a sum of money for the product or service extracted by the second extracting unit.

9. The information processing device according to claim 1, wherein the product or service is associated with building equipment handled by a building company.

10. A non-transitory computer readable medium storing a program to allow the computer of an information processing device to execute the steps of:
comparing a first list of a product or service created for a customer before purchase and a second list of a product or service purchased by the customer, and guessing and extracting a product or service which the customer has a potential desire to purchase; and
creating a third list including the product or service extracted for the customer.

11. An information processing device comprising:
a first extracting unit which compares a first list of an object created for a customer before purchase and a second list of an object purchased by the customer, and guesses and extracts an object which the customer has a potential desire to purchase; and
a creating unit which creates a third list for recommendation, to the customer, of the object extracted for the customer.

12. The information processing device according to claim 11, wherein the first extracting unit guesses and extracts at least one of (i) the object which is included in the first list but is not included in the second list and (ii) the object which is included in the first list and a downgraded version of which is included in the second list.

13. The information processing device according to claim 11, wherein the creating unit makes the third list include at least one of a price of the extracted object, a service life of the extracted object, a proposal type of the extracted object, a change point of the first list from the second list with respect to the extracted object, and the number of the first list including the extracted object.

14. The information processing device according to claim 11, wherein the creating unit creates a fourth list including a candidate customer to whom the extracted object is to be recommended, the candidate customer in the fourth list being listed in a descending order of probability of purchasing the extracted object.

15. The information processing device according to claim 14, further comprising:
an output unit which outputs the third list and the fourth list.

16. The information processing device according to claim 14, further comprising:
a second extracting unit which extracts an object to be sorted from the object extracted by the first extracting unit; and
a sorting unit which sorts the fourth list on the basis of information on the object extracted by the second extracting unit.

17. The information processing device according to claim 16, wherein the second extracting unit determines the object to be sorted on the basis of at least one of an age, a service life, a price range, and a price drop of the object extracted by the first extracting unit, and extracts the determined object from the object extracted by the first extracting unit.

18. The information processing device according to claim 16, wherein the sorting unit sorts the fourth list on the basis of at least one of a change point of the first list from the second list with respect to the object extracted by the second extracting unit, the number of the first list including the object extracted by the second extracting unit, and a sum of money for the object extracted by the second extracting unit.

19. The information processing device according to claim 11, wherein the object is associated with building equipment handled by a building company.
